(19) United States
(12) Patent Application Publication
(10) Pub. No.: US 2026/0050487 A1
(43) Pub. Date: Feb. 19, 2026

(54) Identity Collection Membership Auditing

(71) Applicant: Oracle International Corporation, Redwood Shores, CA (US)

(72) Inventors: Bryon Ford, St. George, UT (US); Anand Puntambekar, Bengaluru (IN); Giri Kothapalli, Allen, TX (US); Joseph Gillette, Dallas, TX (US); Jason Cotton, Leander, TX (US)

(73) Assignee: Oracle International Corporation, Redwood Shores, CA (US)

(21) Appl. No.: 18/807,623

(22) Filed: Aug. 16, 2024

(51) Int. Cl. G06F 9/50

(52) U.S. Cl. CPC G06F 9/5077; G06F 9/5027

(57) ABSTRACT

Techniques for identity collection (IC) membership auditing include: determining, based on IC-to-identity mappings, a number of members of a particular IC; determining, based on IC-to-resource mappings, a number of computing resources accessible to the particular IC; determining one or more parameter values for an IC membership model that defines an inverse relationship between a number of computing resources accessible to a given IC and an expected number of members of the given IC; applying the number of computing resources accessible to the particular IC and the one or more parameter values to the IC membership model, to obtain an expected number of members of the particular IC; and responsive to determining that the number of members of the particular IC exceeds the expected number of members of the particular IC, placing the particular IC under administrative review.

### TECHNICAL FIELD

The present disclosure relates to managing identity collections. In particular, the present disclosure relates to auditing identity collection membership.

### BACKGROUND

In computing, identities are the unique identifiers and attributes associated with individual entities that interact with a system. An identity may be associated with a human user. Alternatively, an identity may be associated with a non-human entity such as an application, serverless function, Internet-of-Things (IoT) device, or another kind of non-human entity. Computer systems rely on identities for functions such as system security, user management, and personalization. An identity collection is a set of identities that have one or more attributes (e.g., specific access rights and permissions tailored to a shared role) in common. For example, members of an identity collection may have access to a particular computing resource, while identities that are not members of the identity collection may not have access to that particular computing resource. Identity collections allow for managing the attributes associated with groups of identities, which is generally more efficient than managing the attributes associated with individual identities. Because identity collections grant access to particular computing resources, it is important to ensure that the appropriate identities belong to each identity collection.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A and 1B illustrate a system in accordance with one or more embodiments;

FIG. 2 illustrates an example set of operations for identity collection membership auditing in accordance with one or more embodiments;

FIGS. 3 and 4 illustrate example sets of operations for using an identity collection membership model to audit an identity collection's membership in accordance with one or more embodiments;

FIGS. 5A-5H illustrate examples of identity collection membership models in accordance with one or more embodiments;

FIG. 6 illustrates an example of a user interface in accordance with one or more embodiments;

FIG. 7 illustrates an example of mappings in accordance with one or more embodiments; and

FIG. 8 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. IDENTITY COLLECTION MEMBERSHIP AUDITING SYSTEM
3. IDENTITY COLLECTION MEMBERSHIP AUDITING
4. EXAMPLE EMBODIMENT
5. PRACTICAL APPLICATIONS AND ADVANTAGES
6. COMPUTER NETWORKS AND CLOUD NETWORKS
7. HARDWARE OVERVIEW
8. MISCELLANEOUS; EXTENSIONS

### 1. General Overview

In general, as the size of an identity collection (IC) increases, the number of resources accessible by that IC is expected to decrease (e.g., by removing access to sensitive resources that age 3 are not suitable for most entities). Conversely, as the size of an IC decreases, the number of resources accessible by that IC is expected to increase (e.g., by granting broad permissions to a small set of trusted entities). This heuristic can be expressed in a model that defines an inverse relationship between the number of resources expected to be accessible to an IC (Res_{expected}) and the number of members of the IC (IC_{count}). Viewed as a graph, the model defines a function in which Res_{expected} decreases as IC_{count} increases. Conversely, the model may define a function in which the expected number of members of the IC decreases as the number of resources available to the IC increases.

In one or more embodiments, the model includes one or more terms that enforce constraints, such as the expected maximum number of resources accessible to an IC, the expected minimum number of resources accessible to an IC, the expected maximum size of an IC, and/or the expected minimum size of an IC.

In one or more embodiments, the model includes one or more tunable parameters. For example, the model may include a tuning parameter K that limits the number or percentage of ICs (e.g., 30% of all ICs) that can be placed under administrative review. In the initial run, the system initializes the tunable model parameters to baseline values.

In one or more embodiments, during a campaign to evaluate IC membership, the system obtains information about existing IC-to-identity mappings, IC-to-resource mappings, and the current values of the parameters used by the model. Based on the number of resources available to a given IC, the model computes the expected IC_{count}. If the actual IC_{count} is more than the expected IC_{count}, the system places the IC under administrative review. To obtain the IC-to-identity and IC-to-resource mappings, the system accesses one or more databases that store (1) mappings of IC identifiers to identities and (2) mappings of those same IC identifiers to resources that are accessible to members of the IC.

In one or more embodiments, for a given IC that is under review, the system generates a user interface that shows (1) the expected IC_{count} versus the actual IC_{count} and (2) a recommendation. The recommendation may indicate specific IC members that are recommended for inclusion or exclusion from the IC. The system may perform peer group analysis to determine the specific IC members that are recommended for inclusion or exclusion.

In one or more embodiments, when a user acts on a recommendation by indicating the entities to include or exclude from the IC, the system updates the model parameters. The system may use a loss function to update the model parameters. The loss function may be a function of the selected IC_{count} and the expected IC_{count}. The system uses the updated parameters in the next run. Thus, the system trains the model on an ongoing basis, without direct user input into the model, and improves recommendations over time.

In a cloud environment, different instances of the model may apply to different tenancies. Thus, the model can be tuned for different tenant's specific IC needs.

One or more embodiments described in this Specification and/or recited in the claims may not be included in this General Overview section.

### 2. Identity Collection Membership Auditing System

### 2.1. System Overview

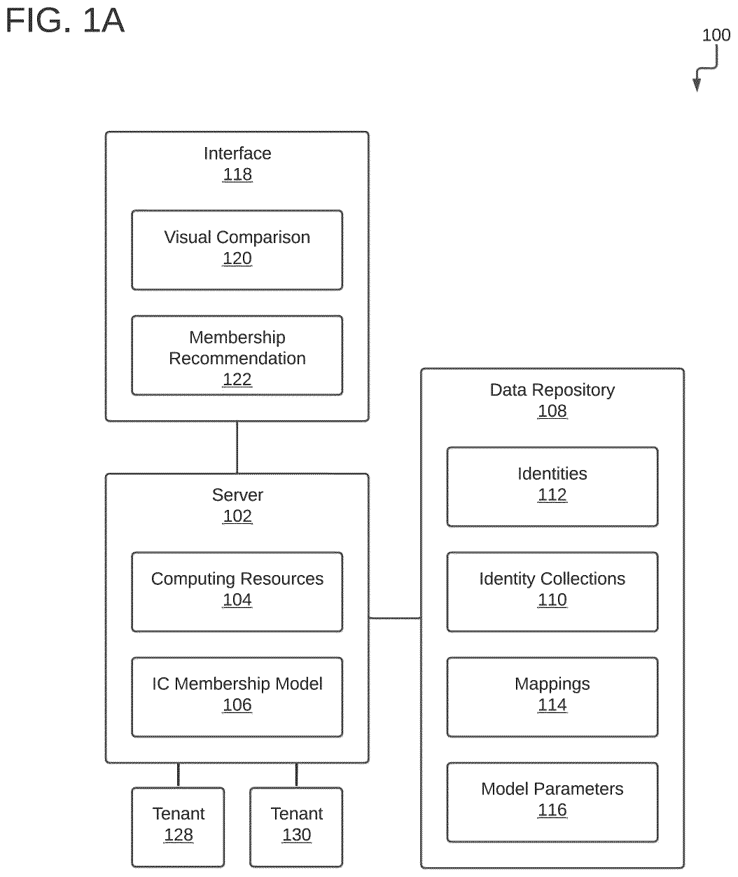

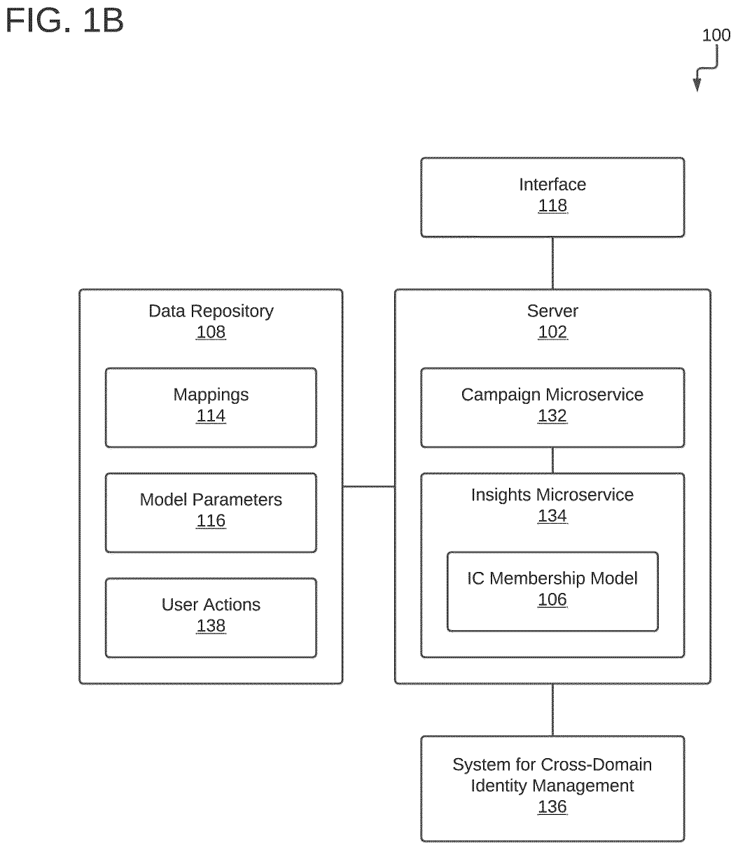

FIGS. 1A and 1B illustrate an identity collection membership auditing system 100 in accordance with one or more embodiments. As illustrated in FIG. 1A, system 100 includes server 102, which includes one or more computing resources 104 and one or more identity collection (IC) membership models 106. System 100 further includes a data repository 108, which includes one or more identity collections 110, identities 112, mappings 114, and one or more model parameters 116. System 100 further includes an interface 118 configured to present one or more visual comparisons 120 and/or membership recommendations 122. System 100 may be configured to service one or more tenants (e.g., tenant 128 and tenant 130). As illustrated in FIG. 1B, system 100 includes a campaign microservice 132, an insights microservice 134, and a cross-domain identity management system 136. Each of these components is discussed in further detail below.

In one or more embodiments, system 100 may include more or fewer components than the components illustrated in FIGS. 1A and 1B. The components illustrated in FIGS. 1A and 1B may be local to or remote from each other. The components illustrated in FIGS. 1A and 1B may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks.”

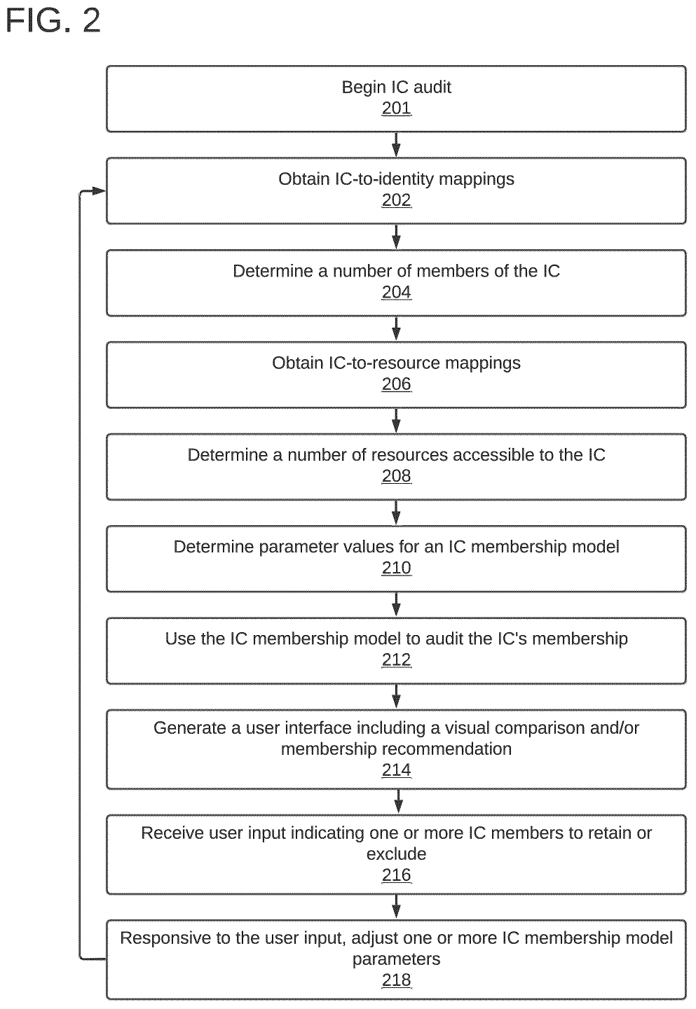

In one or more embodiments, server 102 refers to hardware and/or software configured to perform operations described herein for identity collection membership auditing. Examples of operations for identity collection membership auditing are described below with reference to FIGS. 2-4.

In one or more embodiments, identities 112 include unique identifiers and attributes associated with individual entities (i.e., human and/or non-human entities) that interact with system 100. For example, an identity 112 may include a unique identifier (e.g., a database key field or other kind of unique identifier) that uniquely identifies that particular identity 112. An identity 112 may include various attributes, such as a user's name, email address, telephone number, department, job title, geographic location, etc. An identity 112 that is associated with a non-human entity may include attributes such as a process name, owner, etc. In general, identities 112 allow for the unique identification and management of the individual entities that interact with system 100.

In one or more embodiments, identity collections 110 are sets of identities 112 that have one or more attributes in common. For example, members of a particular identity collection 110 may have access to a particular computing resource 104, while identities 112 that are not members of that particular identity collection 110 may not have access to that particular computing resource 104. Identity collections 110 may be associated with business departments (e.g., development, product management, design, sales, marketing, customer support, human resources, legal, operations, executive management, etc.), roles (e.g., software development, quality assurance, DevOps, research and development, etc.), and/or other logical groupings of identities 112. A given identity 112 may belong to multiple identity collections 110. In an embodiment, an identity collection 110 includes a unique identifier (e.g., a database key field or other unique identifier) that uniquely identifies that particular identity collection 110.

In one or more embodiments, computing resources 104 are components of server 100 that may be accessible to one or more identities 112. Examples of computing resources 104 include, but are not limited to, the following: central processing unit (CPU) cycles; random access memory (RAM); storage (e.g., hard drives, solid state drives, cloud storage, etc.); graphics processing units (GPUs); network interfaces; operating system (OS) features (e.g., administrative tools); applications; networking resources (e.g., bandwidth, Internet Protocol (IP) addresses, etc.); virtual machines; containers; databases; data lakes; and/or other kinds of computing resources 104. Some computing resources 104 may be physically and/or logically segmented with different segments being separately accessible by one or more identities 112. A particular computing resource 104 is accessible to identities 112 that have the appropriate permissions. One or more embodiments include unique identifiers associated with respective computing resources 114, to uniquely identify the computing resources 104 that are accessible to identities 112 and/or identity collections 110.

In one or more embodiments, mappings 114 indicate associations between identities 112, identity collections 110, and computing resources 104. Mappings 114 may include IC-to-identity mappings that indicate the identities 112 that belong to particular identity collections 110. For example, IC-to-identity mappings may take the form of a database table with columns corresponding to identity collections 110 and identities 112, respectively. A row of the table may store a unique identifier associated with an identity collection 110 and a unique identifier associated with a particular identity 112 belonging to that identity collection 110. If multiple identities 112 belong to the same identity collection 110, the table may include multiple rows corresponding to respective IC-to-identity mappings.

Alternatively or additionally, mappings 114 may include IC-to-resource mappings that indicate the computing resources 104 that are accessible to particular identity collections 110. For example, IC-to-resource mappings may take the form of a database table with columns corresponding to identity collections 110 and computing resources 104, respectively. A row of the table may store a unique identifier associated with an identity collection 110 and a unique identifier associated with a particular computing resource 104 that is accessible to that identity collection 110. If multiple computing resources 104 are accessible to the same identity collection 110, the table may include multiple rows corresponding to respective IC-to-resource mapping.

In one or more embodiments, model parameters 116 include one or more parameters used by IC membership model 106. IC membership model 106 is a digital model that defines an inverse relationship between a number of computing resources 104 accessible to a given identity collection 110 and an expected number of members of the given identity collection 110. Conversely, IC membership model 106 may define an inverse relationship between a number of members of a given identity collection 110 and an expected number of computing resources 104 accessible to the given identity collection 110. One or more model parameters 116 may be adjustable by changing the value assigned to a given model parameter 116, making IC membership model 106 a tunable model whose behavior can change over time. Examples of IC membership models 106, model parameters 116, and tuning an IC membership model 106 are described in further detail below.

In one or more embodiments, system 100 is a multi-tenant system. A tenant (such as tenant 128 and/or tenant 130) is a corporation, organization, enterprise or other entity that accesses a shared computing resource, such as one or more of the computing resources 104 managed by server 102. In an embodiment, tenant 128 and tenant 130 are independent from each other. A business or operation of tenant 128 is separate from a business or operation of tenant 130. Server 102 may include separate IC membership models 106 for different tenants. For example, server 102 may include one IC membership model 106 for tenant 128 and another IC membership model 106 for tenant 130. Server 102 may initialize the IC membership models 106 with the same values of model parameters 116 for multiple tenants. Over time, server 102 may adjust one or more model parameters 116 for one or more of the tenants. Specifically, while tenants may begin with identical IC membership models 106, different tenants' IC membership models 106 may diverge over time as the values of one or more model parameters 116 diverge. Thus, server 102 is able to learn different tenants' specific needs and tailor each IC membership model 106 accordingly.

In one or more embodiments, interface 118 refers to hardware and/or software configured to facilitate communications between a user and server 102. Interface 118 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 118 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 118 is specified in one or more other languages, such as Java, C, or C++.

In an embodiment, server 102 is configured to generate a visual comparison 120 for display in interface 118. Visual comparison 120 includes a visual representation of a comparison between an actual number of members of an identity collection 110 and an expected number of members of the identity collection 110, determined as described herein. Additionally or alternatively, visual comparison 120 includes a visual representation of a comparison between an actual number of resources accessible to an identity collection 110 and an expected number of resources accessible to an identity collection 110, determined as described herein. Thus, visual comparison 120 provides an easy-to-understand insight into if the identity collection 110 has too many members for the number of resources to which it has access and/or if the identity collection 110 has access to too many resources for the number of members.

In an embodiment, server 102 is configured to generate a membership recommendation 122 for display in interface 118. A membership recommendation 122 indicates one or more identities 112 that are already members of a particular identity collection 110 and recommended for inclusion or exclusion from the identity collection 110. For example, if the number of members of an identity collection 110 is higher than expected, a membership recommendation 122 may recommend one or more members to exclude from the identity collection 110 to reduce the number of members.

In one or more embodiments, a data repository 108 is any type of storage unit and/or device (e.g., a file system, database, collection of tables, or any other storage mechanism) for storing data. Furthermore, a data repository 108 may include multiple different storage units and/or devices. The multiple different storage units and/or devices may or may not be of the same type or located at the same physical site. Furthermore, a data repository 108 may be implemented or executed on the same computing system as server 102. Additionally, or alternatively, a data repository 108 may be implemented or executed on a computing system separate from server 102. The data repository 108 may be communicatively coupled to server 102 via a direct connection or via a network.

Information describing identities 112, identity collections 110, mappings 114, and/or model parameters 116 may be implemented across any of components within the system 100. However, this information is illustrated within the data repository 108 for purposes of clarity and explanation.

In an embodiment, system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 2.2. Microservice Architecture

In one or more embodiments, system 100 uses a microservice architecture. For example, as shown in FIG. 1B, system 100 may include a campaign microservice 132 and an insights microservice 134. Campaign microservice 132 refers to hardware and/or software configured to perform operations described herein for launching an IC auditing campaign. In particular, campaign microservice 132 is configured to communicate the IC(s) selected for the audit to insights microservice 134. Insights microservice 134 includes IC membership model 106. Insights microservice 134 is configured to obtain mappings 114 and model parameters 116 from data repository 108 and use the IC membership model 106 to audit IC membership based on the data retrieved from data repository 108.

In an embodiment, insights microservice 134 is configured to communicate with a system for cross-domain identity management system (SCIM) 136 to generate recommendations. For example, insights microservice 134 may transmit the expected number of members of an IC (determined using IC membership model 106) and information about the members of the IC to SCIM 136. SCIM 136 may use the information from insights microservice 134 to determine one or more identities recommended for inclusion or exclusion from the IC (e.g., using peer group analysis, as described herein). SCIM 136 may transmit information that describes identities recommended for inclusion and/or exclusion to insights microservice 134.

In an embodiment, when a user takes action with respect to IC membership (e.g., accepting or rejecting a recommendation for inclusion or exclusion), campaign microservice 132 stores information that describes the user actions 138 in data repository 108. As described herein, insights microservice 134 may be configured to tune one or more model parameters 116 based on the user actions 138 and store the tuned value(s) back into data repository 108.

### 3. Identity Collection Membership Auditing

FIG. 2 illustrates an example set of operations for identity collection membership auditing in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system begins an audit of one or more identity collections (Operation 201). The system may perform the audit responsive to a user instruction. For example, the system may receive user input requesting an audit of one or more specific ICs or an audit of multiple ICs managed by the system. Alternatively, the system may perform the audit based on an audit schedule. For example, the system may audit one or more ICs at set intervals such as once per week.

In an embodiment, the system obtains IC-to-identity mappings (Operation 202). To obtain IC-to-identity mappings, the system may access a database table with columns corresponding to identity collections and identities as discussed herein. If the system is performing an audit of one or more specific ICs, then the system may query the table using the IC identifier(s) of the particular IC(s) to be audited. If the system is performing an audit of multiple ICs, then the system may query the table to retrieve records associated with multiple ICs being audited.

In an embodiment, the system determines a number of members of a particular IC (Operation 204). To determine the number of members of the IC, the system may count the number of IC-to-identity mappings associated with that IC. For example, if there are ten IC-to-identity mappings that map the IC to respective identities, then each of those identities is a member of the IC and therefore the IC has ten members.

In an embodiment, the system obtains IC-to-resource mappings (Operation 206). To obtain IC-to-resource mappings, the system may query a database table with columns corresponding to identity collections and computing resources as discussed herein. If the system is performing an audit of one or more specific ICs, then the system may query the table using the IC identifier(s) of the particular IC(s) to be audited. If the system is performing an audit of multiple ICs, then the system may query the table to retrieve records associated with multiple ICs.

In an embodiment, the system determines a number of resources accessible to the IC (Operation 208). To determine the number of resources accessible to the IC, the system may count the number of IC-to-resource mappings associated with that IC. For example, if there are ten IC-to-resource mappings that map the IC to respective resources, then each of those resources is accessible to the IC; therefore, there are ten resources accessible to the IC.

In an embodiment, the system determines parameter values for an IC membership model (Operation 210). For the first time performing an audit using an particular IC membership model, the system may initialize the parameter values to default values. As discussed herein, the system may adjust one or more parameter values for subsequent runs. Accordingly, on subsequent runs, the system may determine the parameter values by retrieving the values from storage (e.g., from a database).

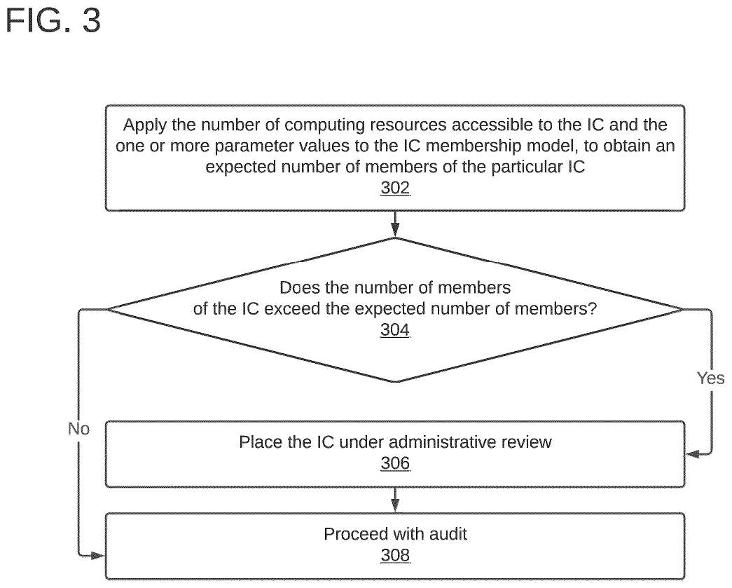

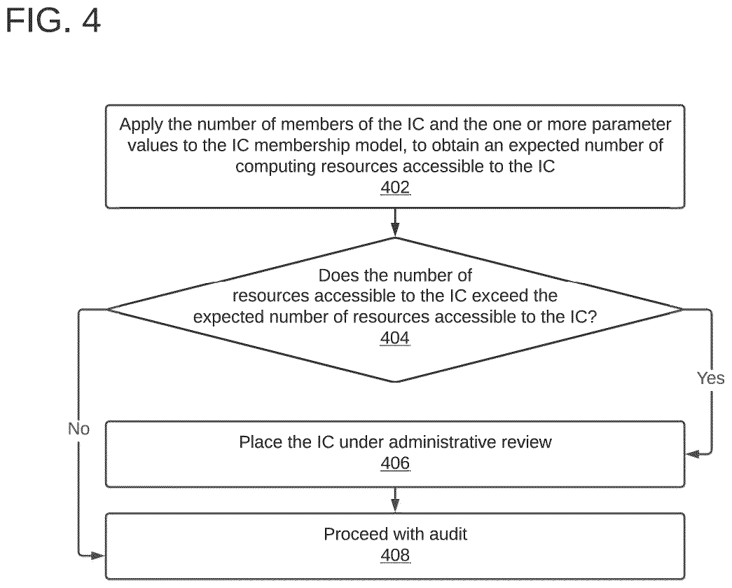

In an embodiment, the system uses the IC membership model to audit the IC's membership. Examples of operations for using an IC membership model to audit an IC's membership are discussed in further detail below with respect to FIGS. 3 and 4. Specifically, in the example shown in FIG. 3, the IC membership model is configured to determine an expected number of members of the IC based on the number of computing resources accessible to the IC. In the example shown in FIG. 4, the IC membership model is configured to determine an expected number of computing resources accessible to the IC based on the number of members of the IC. In either case, the system performs the audit to determine if the actual number of members and/or number of resources accessible to the IC is within expected limits.

As discussed in further detail below, if the actual number of members and/or number of resources accessible to the IC is outside of expected limits, the system may place the IC under administrative review. The system may also place an IC under administrative review for other reasons. For example, even if the number of members of an IC is within the expected number, peer group analysis may determine that one of those members is an outlier and recommended for removal from the IC's membership. In general, whenever the system identifies a recommended change to an IC's membership, the system may place that IC under administrative review.

In an embodiment, the system generates a user interface (Operation 214). The user interface includes information about the results of the audit. The user interface may include a visual comparison, i.e., a visual representation of a comparison between the actual number of IC members and the expected number of IC members, determined as described herein. Additionally or alternatively, the visual comparison includes a visual representation of a comparison between the actual number of resources accessible to the IC and the expected number of resources accessible to the IC, determined as described herein.

Additionally or alternatively, the user interface may include a membership recommendation. A membership recommendation indicates one or more identities that are already members of the IC and recommended for inclusion or exclusion from the IC. For example, if the number of members of the IC is higher than expected, a membership recommendation may recommend one or more members to exclude from the IC to reduce the number of members.

In an embodiment, to generate a member recommendation, the system performs peer group analysis. Peer group analysis refers to techniques for identifying entities that exhibit similar characteristics, such as job roles, access privileges, usage patterns, or other relevant criteria. Peer group analysis identifies outliers that may suggest unauthorized access, insider threats, or other security issues. To perform peer group analysis, the system obtains metadata associated with a set of identities (e.g., members of a given IC). The metadata may include log data that describes entity activities, such as login times, accessed resources, transaction patterns, etc. associated with the identities. Additionally or alternatively, the metadata may include entity attributes, such as roles, length of employment, salary, number of reports, etc. Based on the metadata, the system may use various techniques to identify a baseline or range of expected values for various attributes and/or behaviors. For example, based on historical logins for members of the IC, the system may identify lower and upper bounds of the expected number of logins over a certain period of time (e.g., logins per day or week). If a particular entity's login behavior is outside of that range, peer group analysis flags that entity as an outlier. The system may recommend an outlier for exclusion from the IC.

In an embodiment, the system receives user input indicating one or more IC members to include or exclude (Operation 216). Specifically, the system may receive user input via a user interface generated as discussed above. The user input may indicate whether or not to accept or reject a membership recommendation. Additionally or alternatively, the user input may indicate an identity to include or exclude from the IC even if that particular identity was not included in a membership recommendation. In general, the user input indicates the desired membership of the IC, which may be different than the membership of the IC before the audit.

In an embodiment, responsive to the user input, the system adjusts one or more IC membership model parameters (Operation 218). Specifically, based on the user input, the system determines how many members are in the IC, which may be different than the number of members of the IC before the audit. The system may use this number as input to a loss function to determine an adjustment to one or more of the IC membership model parameters. An example of a loss function is described in further detail below. In an embodiment, the system records user input (e.g., in a database table) and adjusts the IC membership model parameter(s) periodically, e.g., once per week or according to another predetermined schedule.

### 3.1. Applying an IC Membership Model to Obtain an Expected Number of IC Members

FIG. 3 illustrates an example set of operations for using an identity collection membership model to audit an identity collection's membership in accordance with one or more embodiments. Specifically, in the example of FIG. 3, the IC membership model is configured to determine an expected number of members of the IC based on the number of computing resources accessible to the IC.

In an embodiment, the system applies the number of computing resources accessible to the IC and the one or more parameter values to the IC membership model, to obtain an expected number of members of the particular IC (Operation 302). Specifically, the system uses the actual number of computing resources accessible to the IC and the current values of the model parameter(s) as input to the IC membership model. Based on the inputs, the IC membership model produces an expected number of members of the particular IC, which may be different than the actual number of members of the IC.

In an embodiment, the system determines if the number of members of the IC exceeds the expected number of members (Operation 304). Specifically, the system compares the actual number of members of the IC with the expected number of members of the IC (as produced by the IC membership model).

In an embodiment, if the number of members of the IC exceeds the expected number of members, then the system places the IC under administrative review (Operation 306). Placing an IC under administrative review means that the IC's membership needs further attention. For example, the IC's membership may need to be reviewed by a human administrator. Additionally or alternatively, administrative review may include review by an automated process, such as a machine learning model trained to evaluate membership of an IC that has been placed under administrative review.

In an embodiment, whether or not the system places the IC under administrative review, the system proceeds with the audit (Operation 308). For example, the system may be executing an audit campaign that spans multiple ICs and may proceed to repeat the audit process for another IC. Alternatively, the system may be executing an audit of only a single IC, after which the audit process is complete.

### 3.2. Applying an IC Membership Model to Obtain an Expected Number of Resources Accessible to the IC

FIG. 4 illustrates an example set of operations for using an identity collection membership model to audit an identity collection's membership in accordance with one or more embodiments. Specifically, in the example of FIG. 4, the IC membership model is configured to determine an expected number of computing resources accessible to the IC based on the number of members of the IC.

In an embodiment, the system applies the number of IC members and the one or more parameter values to the IC membership model to obtain an expected number of computing resources accessible to the IC (Operation 402). Specifically, the system uses the actual number of members of the IC and the current values of the model parameter(s) as input to the IC membership model. Based on the inputs, the IC membership model produces an expected number of computing resources accessible to the particular IC, which may be different than the actual number of resources accessible to the IC.

In an embodiment, the system determines if the number of resources accessible to the IC exceeds the expected number of resources accessible to the IC (Operation 404). Specifically, the system compares the actual number of resources accessible to the IC with the expected number of resources accessible to the IC (as produced by the IC membership model).

In an embodiment, if the number of resources accessible to the IC exceeds the expected number of resources accessible to the IC, then the system places the IC under administrative review (Operation 406). Placing an IC under administrative review means that the IC's membership needs further attention. For example, the IC's membership may need to be reviewed by a human administrator. Additionally or alternatively, administrative review may include review by an automated process, such as a machine learning model trained to evaluate membership of an IC that has been placed under administrative review.

In an embodiment, whether or not the system places the IC under administrative review, the system proceeds with the audit (Operation 408). For example, the system may be executing an audit campaign that spans multiple ICs and may proceed to repeat the audit process for another IC. Alternatively, the system may be executing an audit of only a single IC, after which the audit process is complete.

### 4. Example Embodiments

Detailed examples are described below for purposes of clarity. Components and/or operations described below should be understood as specifics example which may not be applicable to certain embodiments. Accordingly, components and/or operations described below should not be construed as limiting the scope of any of the claims.

### 4.1. IC Membership Models

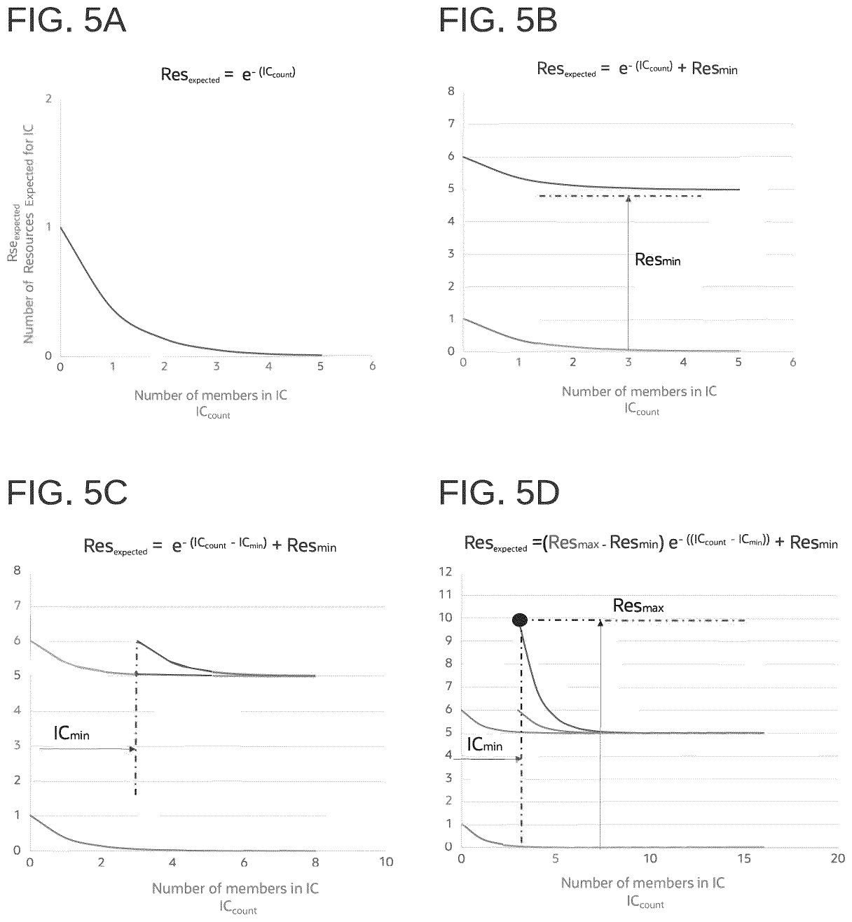

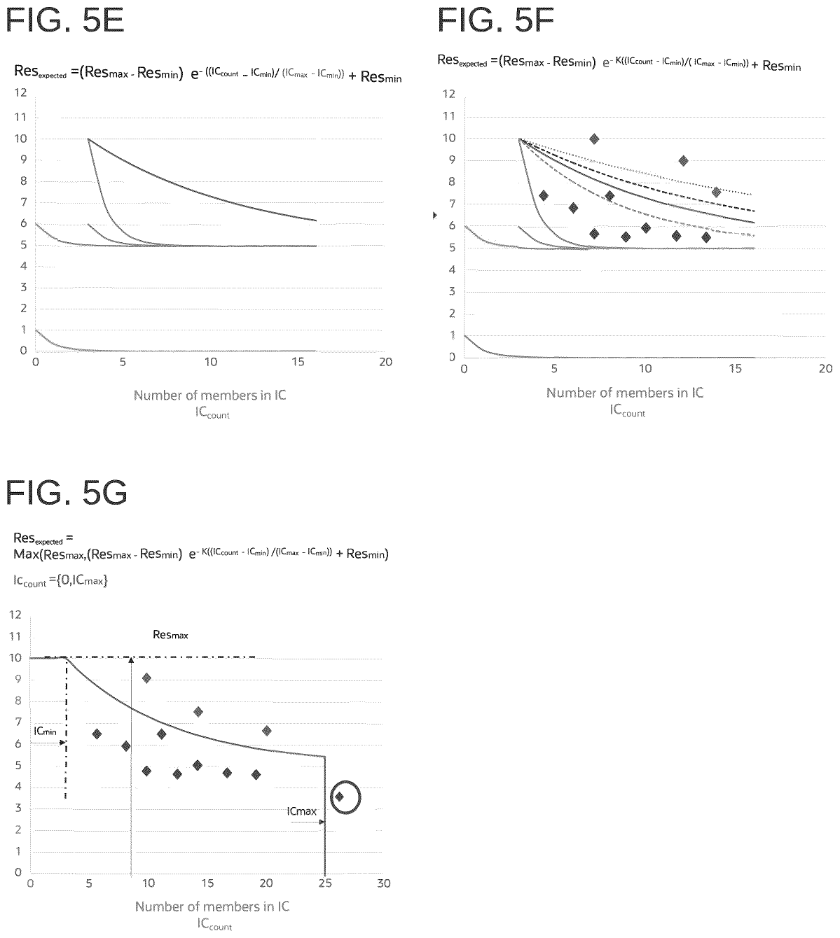

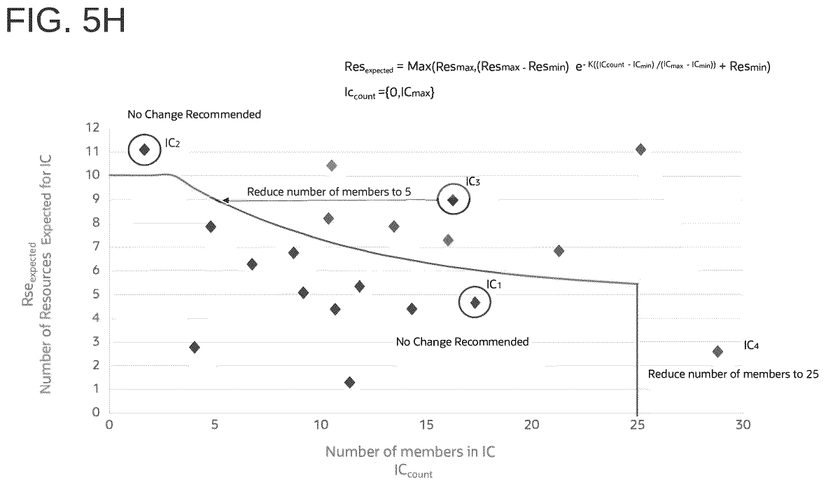

FIGS. 5A-5H illustrate examples of identity collection membership models in accordance with one or more embodiments.

As seen in FIG. 5A, an IC membership model may be expressed as

$${Res}_{expected} = {e}^{- ( {IC}_{count} )} ,$$

where Res_{expected} is the expected number of resources accessible to an IC having a number of members IC_{count}. This model defines an inverse relationship between the number of members of an IC and the expected number of resources accessible to the IC. Specifically, the model defines an exponential decaying curve where the x-axis represents the number of members of an IC and the y-axis represents the expected number of resources accessible to the IC.

In FIG. 5B, the IC membership model is expressed as

$${Res}_{expected} = {e}^{- ( {IC}_{count} )} + {Res}_{min} .$$

Here, Resₘᵢₙ represents the first quantile of the resource count accessible to the IC. As seen in FIG. 5B, this modification shifts the curve upward on the y-axis. Thus, the model incorporates a baseline number of expected resources that is greater than zero.

In FIG. 5C, the IC membership model is expressed as

$${Res}_{expected} = {e}^{- ( ( {IC}_{count} - {IC}_{min} ) )} + {Res}_{min} .$$

Here, ICₘᵢₙ represents the first quantile of the number of members of the IC. As seen in FIG. 5C, this modification shifts the curve rightward on the x-axis. Thus, the model enforces a baseline number of members that is greater than zero.

In FIG. 5D, the IC membership model is expressed as

$${Res}_{expected} = ( {Res}_{max} - {Res}_{min} ) {e}^{- ( ( {IC}_{count} - {IC}_{min} ) )} + {Res}_{min} .$$

Here, Resₘₐₓ represents the third quantiles of the number of resources accessible to the IC. As seen in FIG. 5D, this modification increases the number of resources expected to be available to the IC when IC_{count}=ICₘᵢₙ.

In FIG. 5E, the IC membership model is expressed as

$${Res}_{expected} = ( {Res}_{max} - {Res}_{min} ) {e}^{- ( ( {IC}_{count} - {IC}_{min} ) / ( {IC}_{max} - {IC}_{min} ) )} + {Res}_{min} .$$

Here, ICₘₐₓ represents the third quantile of the number of members of an IC. As seen in FIG. 5E, this modification smooths the curve, providing a more gradual decline in Res_{expected} from ICₘᵢₙ to ICₘₐₓ.

In FIG. 5F, the IC membership model is expressed as

$${Res}_{expected} = ( {Res}_{max} - {Res}_{min} ) {e}^{- K ( \frac{( {IC}_{count} - {IC}_{min} )}{{IC}_{max} - {IC}_{min}} )} + {Res}_{min} .$$

Here, K is a tuning parameter that the system may adjust to achieve a particular auditing goal, such as controlling IC distribution above and below the curve. For example, the system may assign a value to K such that for a set of ICs being audited, the number of ICs above the curve is one third (or some other number or fraction) of the total IC count while still retaining upper and lower bounds. The dashed lines in FIG. 5F show how the curve changes for different values of K, either sloping more suddenly to exclude more ICs under the curve or sloping more gradually to include more ICs under the curve.

In FIG. 5G, the IC membership model is expressed as

$${Res}_{expected} = Max ( {Res}_{max} , ( {Res}_{max} - {Res}_{min} ) {e}^{- K ( \frac{( {IC}_{count} - {IC}_{min} )}{{IC}_{max} - {IC}_{min}} )} + {Res}_{min} ) .$$

This modification ensures that any IC having an IC_{count} greater than ICₘₐₓ will be placed under administrative review, because those ICs have disproportionately high membership counts. As a result, the number of members of a given IC can be expressed as the range IC_{count}={0, ICₘₐₓ}.

In an embodiment, one or more parameters of the IC membership model are tunable parameters. For example, one or more of Resₘₐₓ, Resₘᵢₙ·ICₘₐₓ, ICₘᵢₙ, and/or K may be tunable parameters. On the first iteration of using the IC membership model, the system may initialize the tunable parameters Resₘₐₓ, Resₘᵢₙ. ICₘₐₓ, ICₘᵢₙ, and/or K to baseline values, e.g., 1. The system may adjust K within constraints, so one third of the ICs being audited are under the curve and therefore placed under administrative review.

FIG. 5H illustrates an application of the IC membership model to a set of ICs being audited. In this example, Resₘₐₓ=10 and ICₘₐₓ=25. If the number of members of an IC is below ICₘᵢₙ, the IC is not placed under administrative review. One rationale for this approach is that it is not unusual for an IC with very few members to have access to more computing resources. Thus, IC₂ is not placed under administrative review, while the other ICs above the curve (e.g., IC₃) are placed under administrative review with a recommendation to decrease the number of members to a point below the curve. ICs that are already below the curve (e.g., IC₁) are not placed under administrative review. If the curve were to extend beyond ICₘₐₓ, IC₄ would not be placed under administrative review. However, because the IC membership model enforces ICₘₐₓ, IC₄ is placed under administrative review with a recommendation to decrease the number of members to ICₘₐₓ.

The examples illustrated in FIG. 5A-5H use an IC membership model that determines an expected number of resources accessible to an IC based on the number of members of the IC. As discussed herein, an IC membership model may instead determine an expected number of members of an IC based on the number of resources accessible to the IC. In this case, in one example, the IC membership model may be expressed as

$$Expected {IC}_{count} = Max ( {I}_{1} \cdot {IC}_{min} , \frac{( {I}_{2} \cdot {IC}_{max} - {I}_{1} \cdot {IC}_{min} ) \cdot log ( \frac{{Res}_{count} - {R}_{1} \cdot {Res}_{min}}{{R}_{2} \cdot {Res}_{max} - {R}_{1} \cdot {Res}_{min}} )}{- 1 \cdot K} + {I}_{1} \cdot {IC}_{min} )$$

In an embodiment, one or more parameters of the IC membership model are tunable parameters. For example, one or more of I₁, I₂·R₁, R₂, and/or K may be tunable parameters. On the first iteration of using the IC membership model, the system may initialize the tunable parameters I₁, I₂·R₁, R₂, and/or K to baseline values, e.g., 1. The system may adjust K within constraints, so one third of the ICs being audited are under the curve and therefore placed under administrative review.

### 4.2. Loss Function

As discussed above, the system may adjust these parameters periodically (e.g., once per week) responsive to user input. In this example, the IC membership model is expressed as

$$Expected {IC}_{count} = Max ( {I}_{1} \cdot {IC}_{min} , \frac{( {I}_{2} \cdot {IC}_{max} - {I}_{1} \cdot {IC}_{min} ) \cdot log ( \frac{{Res}_{count} - {R}_{1} \cdot {Res}_{min}}{{R}_{2} \cdot {Res}_{max} - {R}_{1} \cdot {Res}_{min}} )}{- 1 \cdot K} + {I}_{1} \cdot {IC}_{min} )$$

This model was discussed in further detail above. Here, the tunable parameters are I₁, I₂, R₁, R₂, and K. For a series of auditing campaigns over time (e.g., weekly), the system may initialize the parameter values to 1 and adjust K, so a particular number or percentage (e.g., one third) of ICs are placed under administrative review.

Continuing the example, in one or more embodiments, a loss function may be expressed as

$$Loss Function = {\sum }_{C = 1}^{C = n} \frac{{( ( Selected {IC}_{count} ) - ( Expected {IC}_{count} ) )}_{campaign}^{2}}{C}$$

where C is the sequential number of the campaign in the series (e.g., C=1 for the first run in the series, C=2 for the second run in the series, etc.). Tuning the parameters may use the loss function as follows:

$${I}_{1} = {I}_{1} - α \frac{\partial Loss Function}{\partial {I}_{1}}$$

$${I}_{2} = {I}_{2} - α \frac{\partial Loss Function}{\partial {I}_{2}}$$

$${R}_{1} = {R}_{1} - α \frac{\partial Loss Function}{\partial {R}_{1}}$$

$${R}_{2} = {R}_{2} - α \frac{\partial Loss Function}{\partial {R}_{2}}$$

$$K = K - α \frac{\partial Loss Function}{\partial K}$$

In these examples, application of the loss function is subject to the following constraints:

$${I}_{1} * {IC}_{min} < {I}_{2} * {IC}_{max}$$

$${R}_{1} * {Res}_{min} < {R}_{2} * {Res}_{max}$$

$$0.6 \leq {I}_{1} , {I}_{2} , {R}_{1} , {R}_{2} , K \leq 1.2$$

$$0.01 \leq α \leq 0.1$$

where α is a learning rate parameter.

### 4.3. User Interface

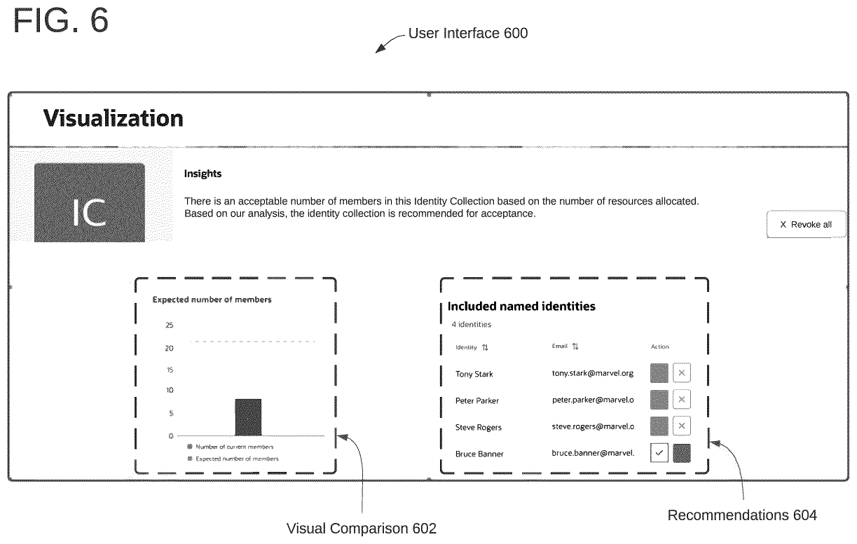

FIG. 6 illustrates an example of a user interface in accordance with one or more embodiments. Specifically, in the example of FIG. 6, a user interface 600 includes a visual comparison 602 and recommendations 604. The visual comparison 602 indicates that the current number of IC members under review is less than the expected number of members. However, based on peer group analysis, the recommendation 604 indicates that of the named identities belonging to the IC, the entity “Bruce Banner” is recommended for removal from the IC. Using the checkboxes, an administrator may choose to either include or exclude a given identity from membership in the IC. The number of members selected for inclusion may then feed into a loss function as described above, to update the IC membership model for improved performance in future iterations.

### 4.4. Mappings

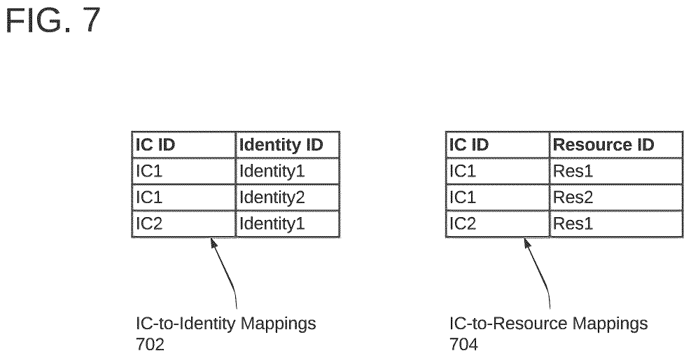

FIG. 7 illustrates an example of mappings in accordance with one or more embodiments. Specifically, FIG. 7 illustrates examples of IC-to-identity mappings 702 and IC-to-resource mappings 704.

In the IC-to-identity mappings 702, the left column stores a unique identifier associated with a particular IC. The right column stores a unique identifier associated with a particular identity. Thus, each row stores a mapping of a particular IC to a particular identity. A particular IC may be mapped to multiple identities. For example, in FIG. 7, IC₁ is mapped to both Identity1 and Identity2, indicating that both those identities are members of IC₁.

In the IC-to-resource mappings 704, the left column stores a unique identifier associated with a particular IC. The right column stores a unique identifier associated with a particular computing resource. Thus, each row stores a mapping of a particular IC to a particular computing resource. A particular IC may be mapped to multiple computing resources. For example, in FIG. 7, IC1 is mapped to both Res1 and Res2, indicating that IC1 has access to both those resources.

### 5. Practical Applications and Advantages

One or more embodiments improve the functioning of a computer system by helping identify and mitigate security vulnerabilities. Specifically, one or more embodiments align with the security principle of “least privilege,” whereby entities should have the minimum levels of access necessary to perform their tasks and nothing more. The fewer members that have access to a given computing resource, the less likelihood there is of that computing resource being misused either unintentionally or deliberately. For example:
If the computing resource is a processor, limiting the number of entities that have access to the processor reduces the likelihood of an entity inadvertently or deliberately launching a process that improperly ties up processor cycles and thereby degrades the system's overall processing capability.
If the computing resource is a network interface, limiting the number of entities that have access to the interface reduces the likelihood of an entity inadvertently or deliberately launching a process that improperly consumes network bandwidth and thereby degrades the system's overall networking capability.
If the computing resource is a storage medium, limiting the number of entities that have access to the storage medium reduces the likelihood of an entity inadvertently or deliberately launching a process that improperly consumes storage space and thereby degrades the system's overall storage capability.
If the computing resource is a system process, limiting the number of entities that have access to the process reduces the likelihood of an entity inadvertently or deliberately stopping the system process at an improper time and thereby negatively impacting whatever system functions relied on that process.

In general, techniques described herein help ensure that as the number of computing resources accessible to a given IC increases, the number of members of that IC decreases, thus reducing the risks associated with more expansive access. Such risks may include, but are not limited to, misuse of computing resources in ways that degrade system performance.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

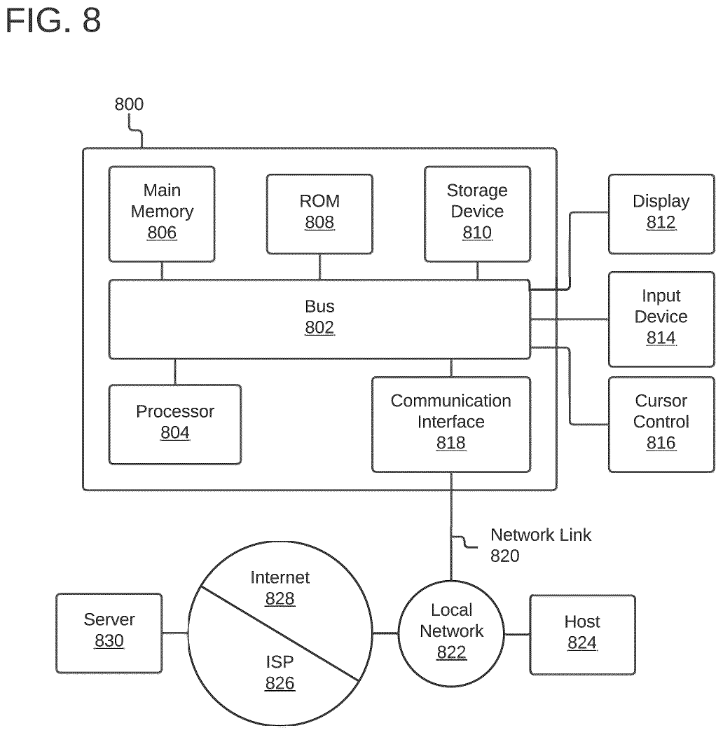

For example, FIG. 8 is a block diagram that illustrates a computer system 800 upon which an embodiment of the disclosure may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or a Solid State Drive (SSD) is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
determining, by an identity collection (IC) auditing system based on a set of IC-to-identity mappings that indicate one or more members of a particular IC, a number of members of the particular IC;
determining, by the IC auditing system based on a set of IC-to-resource mappings that indicate one or more computing resources accessible to the particular IC, a number of computing resources accessible to the particular IC;
determining, by the IC auditing system, one or more parameter values for an IC membership model that defines an inverse relationship between a number of computing resources accessible to a given IC and an expected number of members of the given IC;
applying, by the IC auditing system, the number of computing resources accessible to the particular IC and the one or more parameter values to the IC membership model, to obtain an expected number of members of the particular IC;
determining, by the IC auditing system, that the number of members of the particular IC exceeds the expected number of members of the particular IC;
responsive to determining that the number of members of the particular IC exceeds the expected number of members of the particular IC: placing, by the IC auditing system, the particular IC under administrative review;
wherein the method is performed by at least one device including a hardware processor.

2. The method of claim 1, wherein the IC membership model comprises a constraint on an expected maximum number of computing resources accessible to the given IC.

3. The method of claim 1, wherein the IC membership model comprises a constraint on an expected minimum number of computing resources accessible to the given IC.

4. The method of claim 1, wherein the IC membership model comprises a constraint on an expected maximum number of members of the given IC.

5. The method of claim 1, wherein the IC membership model comprises a constraint on an expected minimum number of members of the given IC.

6. The method of claim 1:
wherein the particular IC is one of a plurality ICs audited by the IC auditing system;
wherein the one or more parameter values comprises a tuning parameter value that limits a number of the plurality of ICs that can be placed under administrative review in a given audit campaign.

7. The method of claim 1:
wherein the particular IC is one of a plurality ICs audited by the IC auditing system;
wherein the one or more parameter values comprises a tuning parameter value that limits a percentage of the plurality of ICs that can be placed under administrative review in a given audit campaign.

8. The method of claim 1, further comprising:
obtaining, by the IC auditing system, the set of IC-to-identity mappings and the set of IC-to-resource mappings from one or more databases configured to store:
(a) mappings of IC identifiers to member identifiers; and
(b) mappings of the IC identifiers to computing resource identifiers.

9. The method of claim 1, further comprising:
generating, by the IC auditing system, a user interface comprising a visual representation of a comparison between the number of members of the particular IC and the expected number of members of the particular IC.

10. The method of claim 1, further comprising:
generating, by the IC auditing system, a user interface that indicates one or more specific members of the particular IC who are recommended, respectively, for inclusion or inclusion in the particular IC.

11. The method of claim 10, further comprising:
performing, by the IC auditing system, peer group analysis on the one or more members of the particular IC, to determine the one or more specific members of the particular IC who are recommended, respectively, for inclusion or inclusion in the particular IC.

12. The method of claim 1, further comprising:
initializing, by the IC auditing system, the one or more parameter values to respective baseline values.

13. The method of claim 12, further comprising:
receiving, by the IC auditing system, user input indicating one or more members of the IC to include or exclude, respectively, from membership in the particular IC;
responsive to receiving the user input: adjusting a parameter value in the one or more parameter values;
applying, by the IC auditing system, the adjusted parameter value to a subsequent application of the IC membership model.

14. The method of claim 13, wherein adjusting the parameter value comprises applying a loss function that accepts, as input, the expected number of members of the particular IC and a number of members of the particular IC remaining after receiving the user input.

15. The method of claim 1:
wherein the IC membership model is one of a plurality of IC membership models;
wherein different IC membership models in the plurality of IC membership models apply, respectively, to different tenancies in a cloud environment;
wherein an adjustment to the particular IC membership model does not apply to another IC membership model in the plurality of IC membership models.

16. One or more non-transitory computer-readable media storing instructions which, when executed by one or more hardware processors, cause performance of operations comprising:
determining, by an identity collection (IC) auditing system based on a set of IC-to-identity mappings that indicate one or more members of a particular IC, a number of members of the particular IC;
determining, by the IC auditing system based on a set of IC-to-resource mappings that indicate one or more computing resources accessible to the particular IC, a number of computing resources accessible to the particular IC;
determining, by the IC auditing system, one or more parameter values for an IC membership model that defines an inverse relationship between a number of computing resources accessible to a given IC and an expected number of members of the given IC;
applying, by the IC auditing system, the number of computing resources accessible to the particular IC and the one or more parameter values to the IC membership model, to obtain an expected number of members of the particular IC;
determining, by the IC auditing system, that the number of members of the particular IC exceeds the expected number of members of the particular IC;
responsive to determining that the number of members of the particular IC exceeds the expected number of members of the particular IC: placing, by the IC auditing system, the particular IC under administrative review.

17. A system comprising:
one or more hardware processors;
one or more non-transitory computer-readable media; and
program instructions stored on the one or more non-transitory computer readable media which, when executed by the one or more hardware processors, cause the system to perform operations comprising:
determining, by an identity collection (IC) auditing system based on a set of IC-to-identity mappings that indicate one or more members of a particular IC, a number of members of the particular IC;
determining, by the IC auditing system based on a set of IC-to-resource mappings that indicate one or more computing resources accessible to the particular IC, a number of computing resources accessible to the particular IC;
determining, by the IC auditing system, one or more parameter values for an IC membership model that defines an inverse relationship between a number of computing resources accessible to a given IC and an expected number of members of the given IC;
applying, by the IC auditing system, the number of computing resources accessible to the particular IC and the one or more parameter values to the IC membership model, to obtain an expected number of members of the particular IC;
determining, by the IC auditing system, that the number of members of the particular IC exceeds the expected number of members of the particular IC;
responsive to determining that the number of members of the particular IC exceeds the expected number of members of the particular IC: placing, by the IC auditing system, the particular IC under administrative review.

18. A method comprising:
determining, by an identity collection (IC) auditing system based on a set of IC-to-identity mappings that indicate one or more members of a particular IC, a number of members of the particular IC;
determining, by the IC auditing system based on a set of IC-to-resource mappings that indicate one or more computing resources accessible to the particular IC, a number of computing resources accessible to the particular IC;
determining, by the IC auditing system, one or more parameter values for an IC membership model that defines an inverse relationship between a number of members of a given IC and an expected number of computing resources accessible to the given IC;
applying, by the IC auditing system, the number of members of the particular IC and the one or more parameter values to the IC membership model, to obtain an expected number of computing resources accessible to the particular IC;
determining, by the IC auditing system, that the number of computing resources accessible to the particular IC exceeds the expected number of computing resources accessible to the particular IC;
responsive to determining that the number of computing resources accessible to the particular IC exceeds the expected number of computing resources accessible to the particular IC: placing, by the IC auditing system, the particular IC under administrative review;
wherein the method is performed by at least one device including a hardware processor.

19. One or more non-transitory computer-readable media storing instructions which, when executed by one or more hardware processors, cause performance of operations comprising:
determining, by an identity collection (IC) auditing system based on a set of IC-to-identity mappings that indicate one or more members of a particular IC, a number of members of the particular IC;
determining, by the IC auditing system based on a set of IC-to-resource mappings that indicate one or more computing resources accessible to the particular IC, a number of computing resources accessible to the particular IC;
determining, by the IC auditing system, one or more parameter values for an IC membership model that defines an inverse relationship between a number of members of a given IC and an expected number of computing resources accessible to the given IC;
applying, by the IC auditing system, the number of members of the particular IC and the one or more parameter values to the IC membership model, to obtain an expected number of computing resources accessible to the particular IC;
determining, by the IC auditing system, that the number of computing resources accessible to the particular IC exceeds the expected number of computing resources accessible to the particular IC;
responsive to determining that the number of computing resources accessible to the particular IC exceeds the expected number of computing resources accessible to the particular IC:
placing, by the IC auditing system, the particular IC under administrative review.

20. A system comprising:
one or more hardware processors;
one or more non-transitory computer-readable media; and
program instructions stored on the one or more non-transitory computer readable media which, when executed by the one or more hardware processors, cause the system to perform operations comprising:
determining, by an identity collection (IC) auditing system based on a set of IC-to-identity mappings that indicate one or more members of a particular IC, a number of members of the particular IC;
determining, by the IC auditing system based on a set of IC-to-resource mappings that indicate one or more computing resources accessible to the particular IC, a number of computing resources accessible to the particular IC;
determining, by the IC auditing system, one or more parameter values for an IC membership model that defines an inverse relationship between a number of members of a given IC and an expected number of computing resources accessible to the given IC;
applying, by the IC auditing system, the number of members of the particular IC and the one or more parameter values to the IC membership model, to obtain an expected number of computing resources accessible to the particular IC;
determining, by the IC auditing system, that the number of computing resources accessible to the particular IC exceeds the expected number of computing resources accessible to the particular IC;
responsive to determining that the number of computing resources accessible to the particular IC exceeds the expected number of computing resources accessible to the particular IC: placing, by the IC auditing system, the particular IC under administrative review.
